(19) United States
(12) Patent Application Publication
(10) Pub. No.: US 2018/0020168 A1
(43) Pub. Date: Jan. 18, 2018

(54) CABLE TIEMETHOD FOR TRANSMITTING CHROMA-KEYED VIDEOS TO MOBILE PHONES

(71) Applicants: Lindsay Friedman, Chagrin Falls, OH (US); Rob Newport, North Hollywood, CA (US)

(72) Inventors: Lindsay Friedman, Chagrin Falls, OH (US); Rob Newport, North Hollywood, CA (US)

(21) Appl. No.: 15/651,430

(22) Filed: Jul. 17, 2017

Related U.S. Application Data
(60) Provisional application No. 62/362,645, filed on Jul. 15, 2016.

(51) Int. Cl. H04N 5/275; H04N 21/61; H04N 21/4788; H04N 21/4786; H04N 21/472; H04N 21/414; H04N 21/2743; H04N 21/81; H04N 5/262

(52) U.S. Cl. CPC H04N 5/275; H04N 21/8173; H04N 21/6181; H04N 21/6125; H04N 21/4788; H04N 5/2621; H04N 21/47205; H04N 21/41407; H04N 21/2743; H04N 21/4786

(57) ABSTRACT

A system for transmitting a chroma-keyed video between at least two mobile communication devices. The system includes a first mobile communication device for creating the chroma-keyed video through a software Application and transmitting the chroma-keyed video. A Cloud receives the chroma-keyed video from the first mobile communication device. A second mobile communication device receives the chroma-keyed video from the Cloud. The software Application within the second mobile communication device manipulates the chroma-keyed video received from the Cloud.

### CROSS-REFERENCE TO RELATED APPLICATIONS

This application claims the benefit of U.S. Provisional Patent Application No. 62/362,645 filed on Jul. 15, 2016 which is incorporated in its entirety herein by reference.

### FIELD OF INVENTION

The present invention relates to a system and method for transmitting a chroma-keyed video and in particular, to a system and method transmitting a chroma-keyed video between at least two mobile communication devices.

### BACKGROUND OF THE INVENTION

Chroma key technology is commonly used in the arts of television and film production to replace the background of pictures, videos, and motion pictures. Replacing a background of a picture allows a person filmed in a studio to appear to be in a different environment. The film industry uses chroma key processing to produce visual special effects. For example, a background screen can be replaced with cityscapes, or with any other scene that can be captured or else digitally rendered.

Background replacement using chroma key technology is achieved by first filming a live subject, such as a performer or a presenter, against a monochromatic background screen. Typically, the subject is filmed in front of a blue screen or a green screen. The background screen is then captured separately, using the same lighting as is used to capture the presenter. The background screen captured separately serves as a background reference image. During the chroma keying process, background pixels in the original picture are identified by their monochromatic color. Each pixel in the background reference image is identified individually during the keying process. A replacement background is then substituted, pixel by pixel, for he background blue screen. Each background pixel is substituted with a pixel of the new, replacement background.

### SUMMARY OF THE INVENTION

According to an embodiment of the present invention, there is disclosed a system for transmitting a chroma-keyed video between at least two mobile communication devices. The system includes a first mobile communication device for creating the chroma-keyed video through a software Application and transmitting the chroma-keyed video. A Cloud receives the chroma-keyed video from the first mobile communication device. A second mobile communication device receives the chroma-keyed video from the Cloud. The software Application within the second mobile communication device manipulates the chroma-keyed video received from the Cloud.

According to another embodiment of the present invention, there is disclosed a method for transmitting a chroma-keyed video between at least two mobile communication devices. The method includes creating the chroma-keyed video on a first mobile communication device through a software Application and transmitting the chroma-keyed video. Then, receiving the chroma-keyed video transmitted from the first mobile communication device on a Cloud, followed by receiving the chroma-keyed video from the Cloud on a second mobile communication device. Finally, manipulating the chroma-keyed video received from the Cloud using the software Application within the second mobile communication device.

### BRIEF DESCRIPTION OF THE DRAWINGS

The structure, operation, and advantages of the present invention will become further apparent upon consideration of the following description taken in conjunction with the accompanying figures (FIGS.). The figures are intended to be illustrative, not limiting. Certain elements in some of the figures may be omitted, or illustrated not-to-scale, for illustrative clarity. The cross-sectional views may be in the form of “slices”, or “near-sighted” cross-sectional views, omitting certain background lines which would otherwise be visible in a “true” cross-sectional view, for illustrative clarity.

In the drawings accompanying the description that follows, both reference numerals and legends (labels, text descriptions) may be used to identify elements. If legends are provided, they are intended merely as an aid to the reader, and should not in any way be interpreted as limiting.

FIG. 1 is a schematic view of the system for the removal of the background colors from the video screen of a mobile communication device, in accordance with the present invention.

FIG. 2 is a schematic view of the method of downloading and creating an account within an App used for the removal of the background colors from the video screen of a mobile communication device, in accordance with the present invention.

FIG. 3 is a schematic view of the method by which the user may create and transmit a chroma-keyed video, in accordance with the present invention.

FIG. 4 is a schematic view of the method of the method for chroma-keying a video, in accordance with the present invention.

FIG. 5 is a schematic view of the method of color selection which includes the creation of a three Dimensional color lookup table, in accordance with the present invention.

FIG. 6 is a schematic view of the method of the application of the Color Array for removal from the video buffer, in accordance with the present invention.

FIG. 7 is a schematic view of the method by which a second user may manipulate and modify the video created by a first user, in accordance with the present invention.

### DETAILED DESCRIPTION OF THE PREFERRED EMBODIMENTS

In the description that follows, numerous details are set forth in order to provide a thorough understanding of the present invention. It will be appreciated by those skilled in the art that variations of these specific details are possible while still achieving the results of the present invention. Well-known processing steps are generally not described in detail in order to avoid unnecessarily obfuscating the description of the present invention.

In the description that follows, exemplary dimensions may be presented for an illustrative embodiment of the invention. The dimensions should not be interpreted as limiting. They are included to provide a sense of proportion. Generally speaking, it is the relationship between various elements, where they are located, their contrasting compositions, and sometimes their relative sizes that is of significance.

In the drawings accompanying the description that follows, often both reference numerals and legends (labels, text descriptions) will be used to identify elements. If legends are provided, they are intended merely as an aid to the reader, and should not in any way be interpreted as limiting.

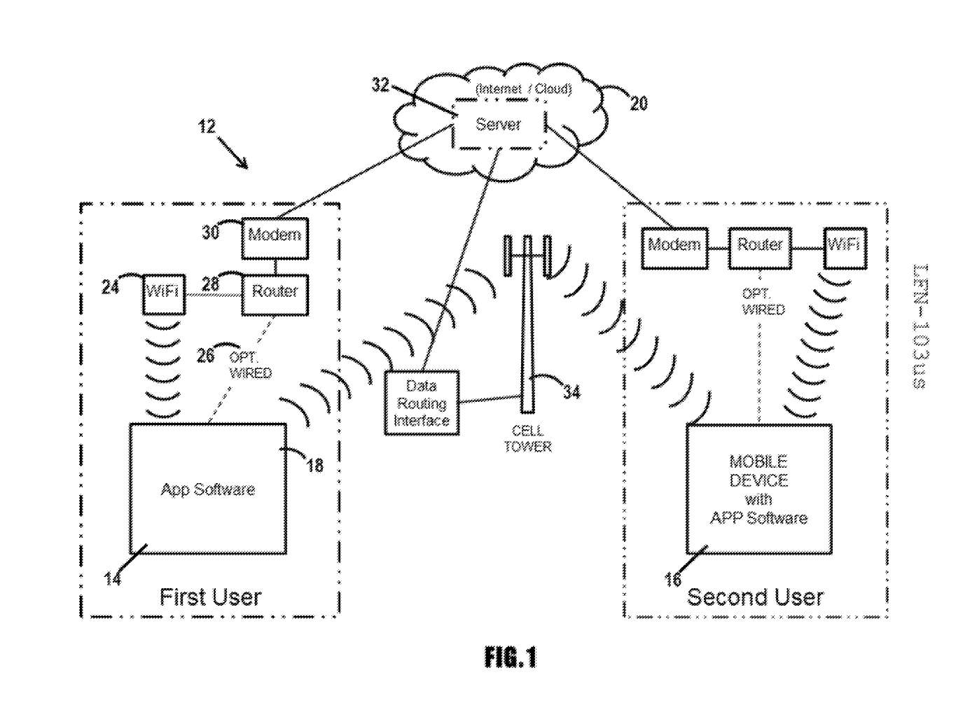

A system 10 and method 12 for transmitting chroma-keyed videos between at least two mobile communication devices, i.e. cell phones of the present invention. As shown in FIG. 1 a system 10 is provided for creating and transmitting a chroma-keyed video between mobile communication devices 14 and 16. In general terms, a chroma-keyed video is created by a first user on the mobile communication device 14 through a software Application 18 (hereafter “App”). The chroma-keyed video is sent by the App 18 via the Cloud 20 or any other mobile messaging service, and is received by second user on the App 22 on his mobile communication device 16. The second user can overlay themselves or otherwise manipulate the received chroma-keyed video. The resulting manipulated chroma-keyed video is transmitted by the App 22 to the Cloud 20, and received by the App 18 in the mobile communication device 14 of the first user. The first user can further manipulate the chroma-keyed video received from the second user on their first mobile communication device 14, and the message chain can continue to the second user or any other additional users. Additional users can be brought into the messaging and the video remixing of the previously manipulated chroma-keyed video.

Referring again to FIG. 1, the Apps 18 and 20 are small special purpose software for first and second mobile devices 14 and 16, respectively, such as smartphones, tablets and the like, which are generally characterized by a hand-held size package that typically combines hardware and software for phone and/or internet communication, for visual/graphical and audio I/O with keypad and/or touchscreen and/or voice command interactive control, and for viewing/listening to video, music, still image, game screens and other graphics. The Apps 18 and 20 include data processing and interactive interface platforms. Typically there are a variety of sensors, receivers and transmitters included in a mobile device such as GPS, radio/Wi-Fi, cell phone, accelerometer, camera image sensors, etc. The device operating system (e.g., Apple iOS, Google Android, etc.) and built-in drivers control everything through overall supervision of interrelated software objects including Apps that may be provided by third parties.

As further seen in FIG. 1, the manner by which the system 10 operates is with a generic computer interface device to manage/control the communication content between the first and second mobile devices 14 and 16, respectively, of the first and second users. For example, the App 18 can transmit the chroma-keyed video to the cloud 20 either through a modem 30 or a cellular tower 34. When using a modem 30, the App 18 can either transmit wirelessly through WiFi 24, or through optical wire 26, to router 28, then to modem 30, and then to the servers 32 in the cloud 20. The Alternatively, App 18 can transmit wirelessly to the cell tower 34, which in turn transmits to a data routing interface 36, and then to the servers 32 in the cloud 20. Then, the chroma-keyed video is sent from the cloud 20 to the App 22 in the second mobile device 16, which communicates with the cloud 20 in an identical fashion as the first mobile communication device 14. The cloud 20 utilizes a network of remote servers 32 hosted on the Internet to store, manage, and process the data sent and received by the first and second mobile communication devices 14 and 16. The remote severs 32 incorporate a hard drive and CPU to interface with the storage and memory of the data sent between the first and second mobile communication devices 16.

In general terms, the system 10 for transmitting chroma-keyed videos to mobile communication devices (hereafter “method”) effectively removes the background of a video on a mobile communication in real time (when the first and second mobile communication devices 14 and 16 allows) or in the cloud 20. Once the background of the video is removed, and only the foreground remains, a user is able to choose video or image backgrounds to replace the original background. The original background can be anything, including those with motion, as long as the user does not blend in. The user is also able to remove the background, add a new background and then stream the video live on their mobile device. While on a call, the user can continuously change out the backgrounds, in essence give a presentation from the airport on their mobile device 14 or 16.

First and second users have the ability to add virtual streams of videos and effects during the videos. Further, users can send both SMS messages and messages via the App 18 and 20, as well as video call. First and second users can add multiple messaging via the App 18 and 20. Further, first and second users can share and post videos across social messaging sites.

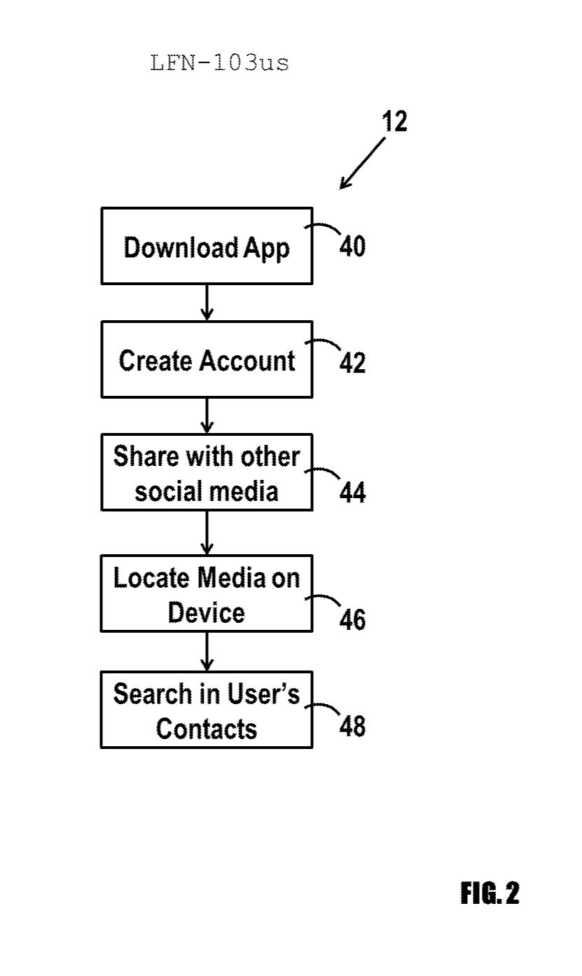

FIG. 2-7 show the method for transmitting chroma-keyed videos between at least two mobile communication devices.

FIG. 2 illustrates the steps by which the user downloads creates an account within the App 18 and 22. The first step of the method 12 in step 40 includes the user downloading the Apps 18 and 22 on a user device. The user device may include a cell phone, smartphone, tablet computer, PDA, or any other portable computing device. The method 12 operates on a mobile software platform such as iPhone OS, Android OS, Palm WebOS, J2ME, Windows Mobile, Flash, Flash Mobile, or other similar mobile software platform.

In step 42, the user may create an account with a personal profile within the Apps 18 and 22. The profile may be created with the Apps 18 and 22. Alternatively, it is within the terms of the embodiment that the profile be created from other social media venues, such as Facebook. The Apps 18 and 22 may have the option of culling provided social media, such as a Facebook page, to create a profile within the Apps.

Further, in step 44, the Apps 18 and 22 determines if the user has affiliated itself with an alternative social network, such as Twitter, Facebook, and Instagram. Assuming all listed social networks are enabled, the content created within the Apps 18 and 22 may be shared to these other forms of social media.

In step 46, the Apps 18 and 22 may search the user's mobile device 14 and 16 to locate any relevant existing media already stored on the device. A library may be created that contains relevant media that the user may access within the Apps 18 and 22. As content is recorded and captured, this media will be added to the library. The library may be stored within the memory of the mobile devices 14 and 16, or alternatively stored within the memory of the servers 32 of the Cloud 20.

In step 48, the Apps 18 and 22 may search amongst the user's contacts, both within the user's mobile device 14 and 16, and within any of the social networks within which the user allows access. A list of contacts is created by the Apps 18 and 22. Further, the user may manually add any additional contacts that he desires with whom he may trade content within the Apps 18 and 22.

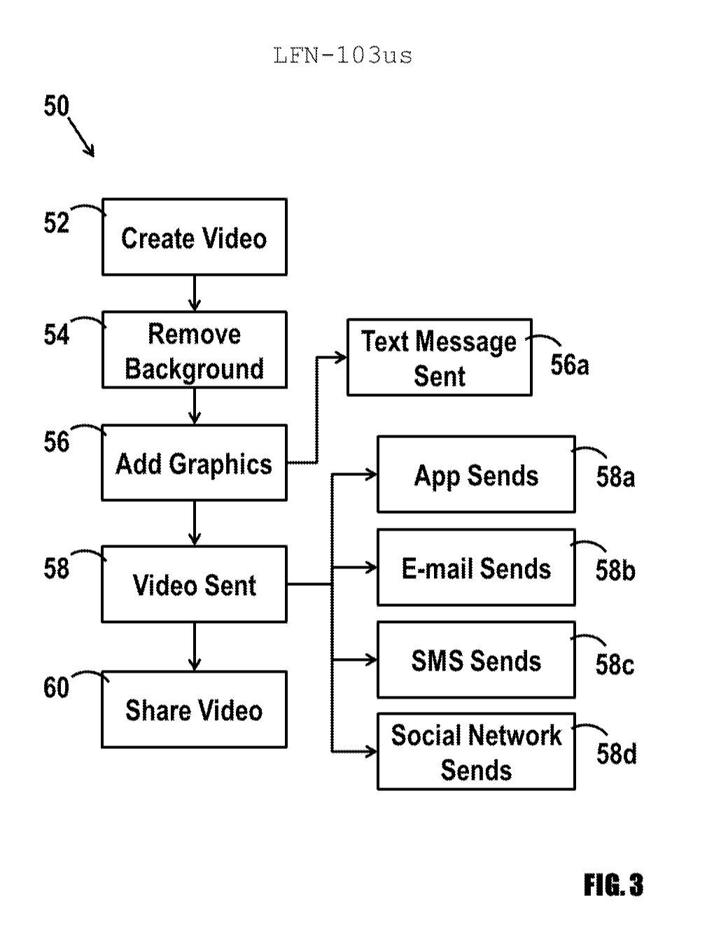

FIG. 3 illustrates the method 50 by which the user may create and transmit a chroma-keyed video. In step 52, the user creates a new video by utilizing the camera on the mobile device or transferring a video from an alternative device, such as a video camera, into the mobile device. Alternatively, the user has the option of selecting from a previously created video that has been stored in the library of Apps 18 and 22.

In step 54, the user is able to remove the background of the selected video from their mobile device within the Apps 18 and 22. It should be noted that the background can consist of any amount of noise, as long as the user does not blend into the background from which they will need to be segmented. The background is eliminated in real time, such that the user can immediately see the removed portion of the video. However, the user may taps on themselves or the person(s) they want to remain in the video.

In step 56, the user may add visuals and virtual graphics and effects to the video, as well as a stream of product placement. In practice, the user can immediately see the image(s) or video(s) that they have placed behind them. The processing will either take place in real time or the video will render in the cloud, depending on the capability of the mobile device. An algorithm implemented into the Apps 18 and 22 determines whether the mobile device is capable of rendering on the device. Alternatively, the user can override and have the video rendered on cloud. In step 56a, if rendered on cloud, a text message will be sent to user when rendering is complete. If rendered in real time, the video is available immediately.

In step 58, the video that has been modified by the user is sent to a second user. The video may be sent through a variety of channels: In step 58a, the video is sent through the Apps 18 and 22; In step 58b, the video is sent through Email; In step 58c, the video is sent through SMS; In step 58d, the video is sent through any other social network.

In step 60, the user may share the video on any other of his social media site or network.

In general terms, the video being shared by the first user is created utilizing chroma key technology, also known as chroma key compositing. This is a visual effects/post-production technique for compositing (layering) two images or video streams together based on color hues (chroma range). The technique has been used heavily in many fields to remove a background from the subject of a photo or video—particularly the news casting, motion picture and videogame industries. A color range in the foreground footage is made transparent, allowing separately filmed background footage or a static image to be inserted into the scene. The chroma keying technique is commonly used in video production and post-production. This technique is also referred to as color keying or by various terms for specific color-related variants such as green screen, and blue screen. Chroma keying can be done with backgrounds of any color that are uniform and distinct, but green and blue backgrounds are more commonly used because they differ most distinctly in hue from most human skin colors.

A typical usage s the process of separating a person in a video from the background. Using a chroma-keying software application, the picture of the person is separated into its component parts-the live person and the background screen. The chroma-key based processing is a technique of processing video objects, utilizing the technique for layering two images or videos together based on color hues. Typically, this technique is to be utilized to remove a background from the subject of a photo or video.

Chroma-keying is often used in the news casting, movie, and video game fields. A commonly known application for key-based processing is for weather forecasts, in which a background blue screen is replaced with a large weather map. The final picture, including the meteorologist standing in front of a national weather map, is then broadcast for viewing. The meteorologist appears to be standing in front of the map when in fact the meteorologist is being filmed in a studio against a plain blue screen.

The chroma-keying in of the disclosed embodiment does not need a plain blue or green screen as a background. The chroma-keying is able to be done with multiple colors via the touch screen on a mobile communication device. The user is able to select the background colors to be removed from the video screen in real time.

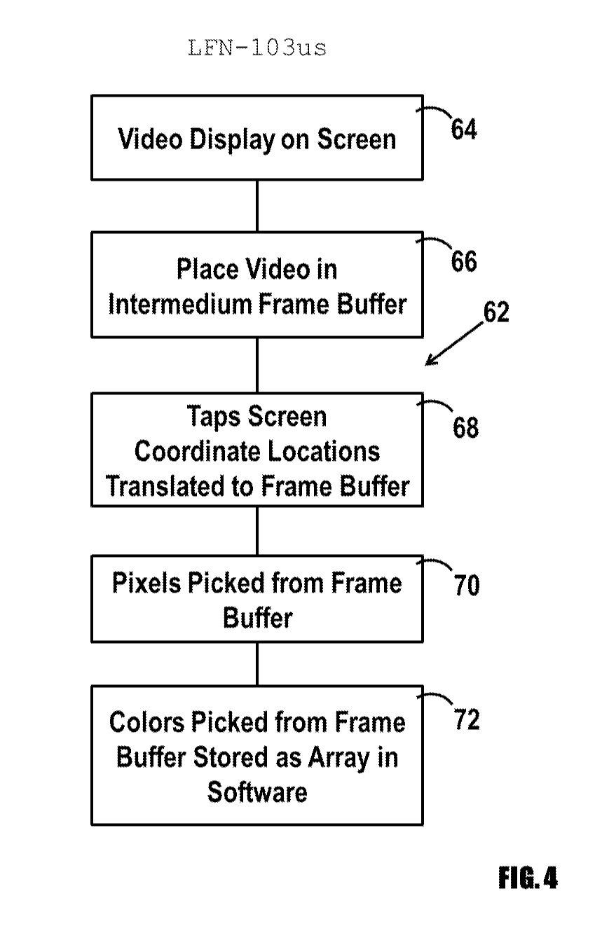

FIG. 4 illustrates the method 62 necessary for chroma-keying a video.

In step 64, the video captured by a video camera is displayed on the screen of the mobile device 14 and 16 in real time.

In step 66, the video captured by the video camera is placed in an intermediary frame buffer of the mobile communication device using the graphics processing unit (GPU) of the mobile communication device 14 and 16.

In step 68, when the user taps on the screen of the communication device 14 and 16, coordinate locations from the screen are translated to the frame buffer.

In step 70, the red, green, and blue pixels are picked up from the frame buffer during the coordinate location translation mentioned herein above. This step is a significant aspect of the preferred embodiment because in the prior art devices, the color space of the image needs to be calibrated to the color space of the chosen color to be extracted. By contrast, in the processing of the present invention, the color is being picked up directly from the frame buffer so no calibration is necessary since the color is coming straight from the image.

In step 72, the color picked from the frame buffer is saved in memory and stored as an array of colors in the software of the present invention.

If desired, the user is able to overlay several other layers of videos above the chroma-keyed video through a sequence of events that occur during a user interaction for chroma keying.

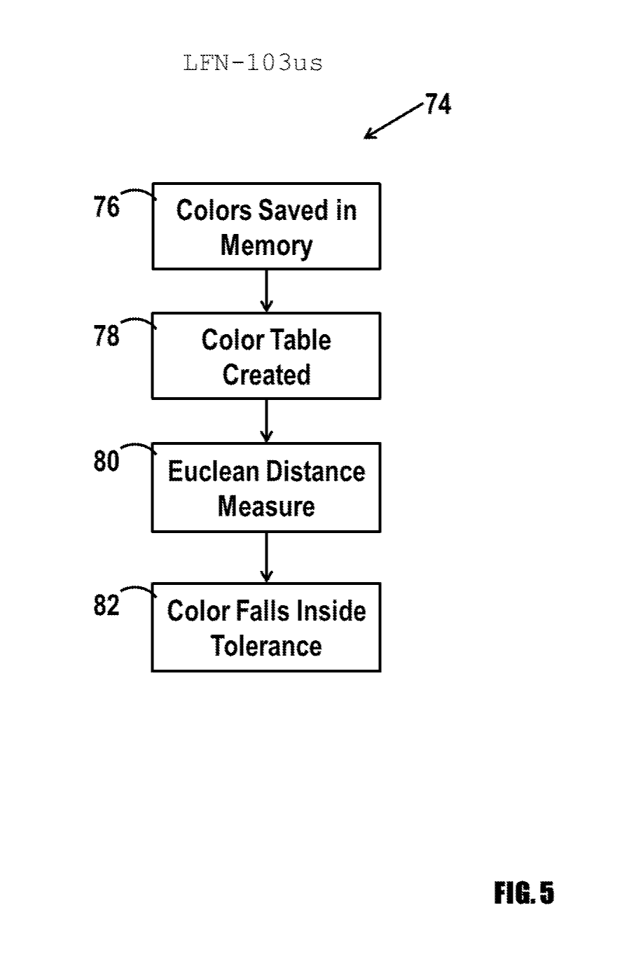

FIG. 5 shows the method 74 of color selection which includes the creation of a three Dimensional (3D) color lookup table (CLUT) with Alpha values by the following steps.

In step 76, the colors are saved in memory and stored as an array are retrieved.

In step 78, a red, green, and blue, Alpha color table is created programmatically to cover all 256×256×256 colors. Note that currently, mobile devices 14 and 16 are incapable of putting the full 256×256×256 color table into memory. Therefore, a trilinear interpolation will be used to calculate interstitial color and alpha values to fill in the areas where memory is sparse. This is a significant portion of the smoothness of the alpha channel translation.

In step 80, as each color is created in the color lookup table, the Euclidean distance is measured from the colors saved in memory to the color in the color lookup table. Note that the Euclidean distance is important in that it determines where and how accurate the replacement occurs. This enables the user to increase or decrease the distance of how much or how little of the values of the adjacent pixels are used in the 3D CLUT.

In step 82, if the color falls inside a predetermined distance, i.e. the tolerance, the color row gets assigned a 0 alpha value.

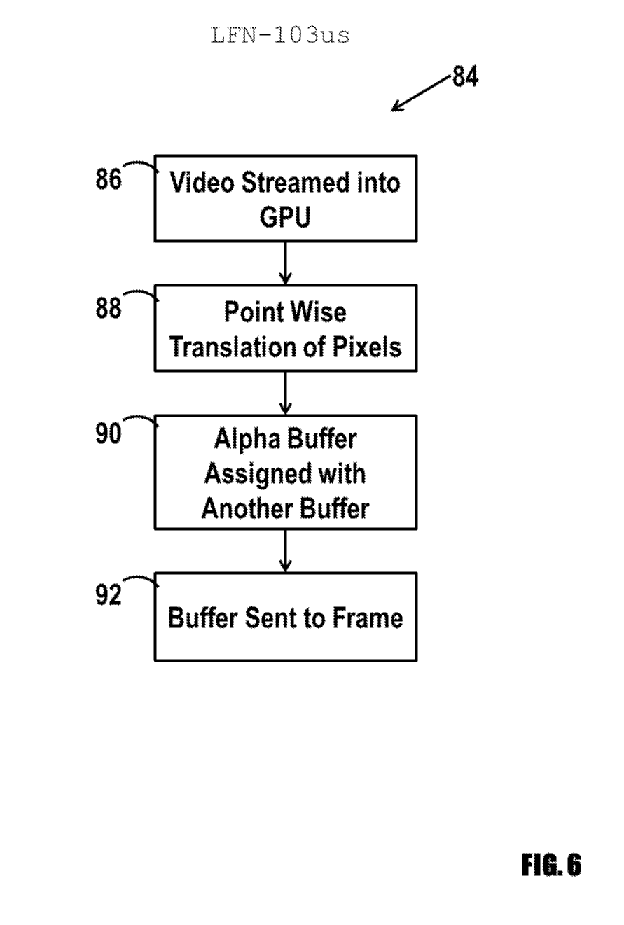

FIG. 6 shows the method 84 of the application of the Color Array for removal from the video buffer. The removal includes the following steps.

In step 86, a video is streamed into a GPU buffer for manipulation and creation of an alpha-assigned buffer.

In step 88, a point-wise translation of the pixels into the alpha-assigned buffer is executed using the color table created above. Note that the translation of one color to another is a straight lookup of one value's row to the row in our custom 3D lookup table.

In step 90, the newly alpha-assigned buffer is combined with a separate video or image buffer.

In step 92, the resulting buffer is sent to the frame for viewing.

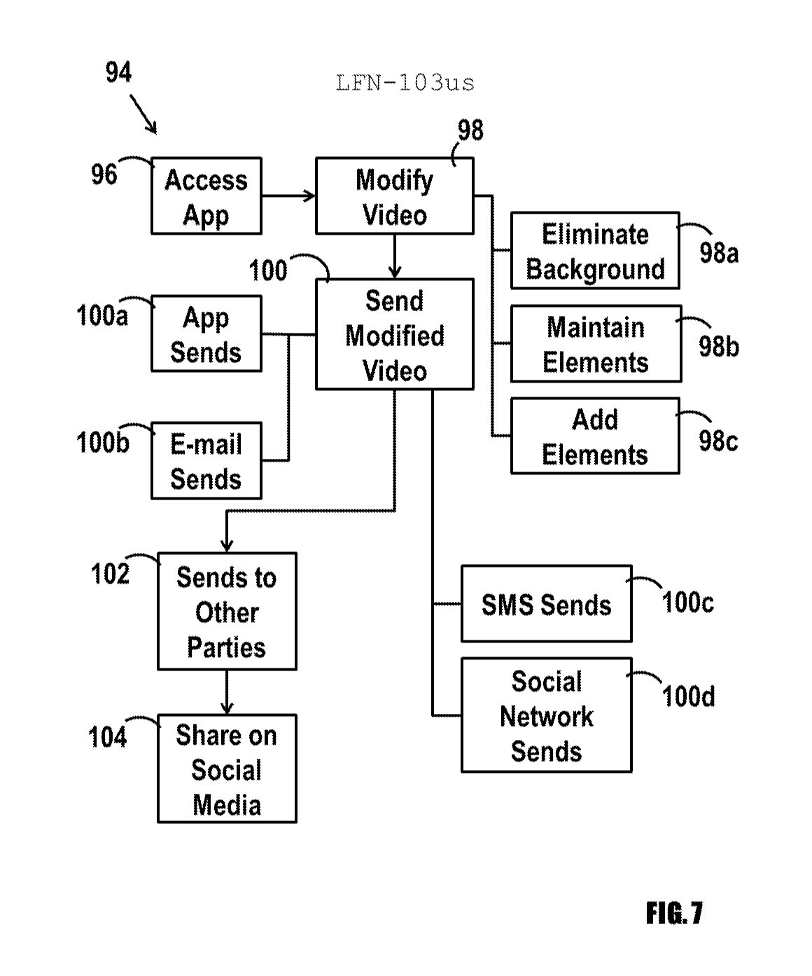

FIG. 7 illustrates the method 94 by which a second user may manipulate and modify the video created by the first user.

In step 96, the second user follows the steps of FIG. 1, to access the Apps 18 and 22 and create a profile therein.

In step 98, the second user has the ability to modify the video in a similar manner of the first user. The second user can film a chroma-key video of themselves to add themselves into the received video. The received video will become the background video for the second user's new video.

In step 98a, the second user may eliminate the background of the original video.

In step 98b, the second user may tap on any elements within the original video to remain therein.

In step 98c, the second user may add themselves or any other desired elements into the video. For example, the second user may add an animated video stream or text to the original video.

In step 100, the second user may send the modified video back to the original user. The video may be sent through a variety of channels: In step 100a, the video is sent through the Apps 18 and 22. In step 100b, the video is sent through Email. In step 100c, the video is sent through SMS. In step 100d, the video is sent through any other social network.

In step 102, the second user may send the modified video to any other desired parties, either through the Apps 18 and 22 or any other method, such as Email. Any of the additional parties have the ability to modify the contents of the video.

In step 104, the second user may share the video on any other of his social media site or network.

It should be noted that any user may create a live chroma-keyed video stream in the Apps 18 and 22. For example, the first user can live video call a video to the second user, and both users may participate on live video stream calls with chroma-keyed backgrounds and inserted backgrounds behind them. Then, either user has the ability to switch out the backgrounds of their live chroma-keyed video stream video while on the live video call.

Although the invention has been shown and described with respect to a certain preferred embodiment or embodiments, certain equivalent alterations and modifications will occur to others skilled in the art upon the reading and understanding of this specification and the annexed drawings. In particular regard to the various functions performed by the above described components (assemblies, devices, etc.) the terms (including a reference to a “means”) used to describe such components are intended to correspond, unless otherwise indicated, to any component which performs the specified function of the described component (i.e., that is functionally equivalent), even though not structurally equivalent to the disclosed structure which performs the function in the herein illustrated exemplary embodiments of the invention. In addition, while a particular feature of the invention may have been disclosed with respect to only one of several embodiments, such feature may be combined with one or more features of the other embodiments as may be desired and advantageous for any given or particular application.

1. A system for transmitting a chroma-keyed video between at least two mobile communication devices, the system comprising;
a first mobile communication device for creating the chroma-keyed video through a software Application and transmitting the chroma-keyed video;
a Cloud to receive the chroma-keyed video from the first mobile communication device;
a second mobile communication device to receive the chroma-keyed video from the Cloud; and
the software Application within the second mobile communication device to manipulate the chroma-keyed video received from the Cloud.

2. The system of claim 1, further including:
the second mobile communication device for transmitting the chroma-keyed video that has been manipulated through the software Application;
the Cloud to receive the chroma-keyed video from the second mobile communication device; and
the first mobile communication device to receive the chroma-keyed video that has been manipulated from the Cloud.

3. The system of claim 1, further including the including a network of remote servers hosted on the Cloud to store, d process the data sent and received by the first and second mobile communication devices.

4. The system of claim 1, further including the software Application providing data processing and interactive interface platforms for the creation and manipulation of the chroma-keyed video.

5. The system of claim 4, further including the software Application transmits the chroma-keyed video through a modem and then to the servers in the cloud.

6. The system of claim 4, further including the software Application transmits the chroma-keyed video wirelessly to a cell tower, which in turn transmits to a data routing interface, and then to the servers in the cloud.

7. A method for transmitting a chroma-keyed video between at least two mobile communication devices, the method comprising;
creating the chroma-keyed video on a first mobile communication device through a software Application;
transmitting the chroma-keyed video;
receiving the chroma-keyed video transmitted from the first mobile communication device on a Cloud;
receiving the chroma-keyed video from the Cloud on a second mobile communication device; and
manipulating the chroma-keyed video received from the Cloud using the software Application within the second mobile communication device.

8. The method of claim 7 further comprising downloading the software Application to the first and second mobile communication devices and creating an account with a personal profile within the software Application.

9. The method of claim 8 further comprising searching the first and second mobile communication devices to locate any relevant existing media already stored on the mobile communication devices to be converted to chroma-keyed video by the software Application.

10. The method of claim 9 further comprising creating a library that contains relevant media that the user may access within the software Application, and content is recorded and captured, it will be added to the library.

11. The method of claim 10 further including storing the library within memory of the first and second mobile communication devices.

12. The method of claim 10 further including storing the library within memory of the servers of the Cloud.

13. The method of claim 12 further including creating the chroma-keyed video by utilizing a camera on the first and second mobile communication devices.

14. The method of claim 13 further including removing the background of the chroma-keyed video using the software Application.

15. The method of claim 14 further including adding visuals, virtual graphics, effects and a stream of product placement to the chroma-keyed video using the software Application.

16. The method of claim 15 further including sending the chroma-keyed video from the software Application within the first mobile communication device through a channel selected from the group consisting of the software Application, Email, SMS, and a social network, to the software Application within the second mobile communication device through the Cloud.

17. The method of claim 16 further including receiving the chroma-keyed video from the Cloud to the software Application within the second mobile communication device.

18. The method of claim 17 further including modifying the received chroma-keyed video.

19. The method of claim 18 further including eliminating the background of the chrom-keyed video.

20. The method of claim 19 further including sending the modified chroma-keyed video from the software Application within the second mobile communication device through a channel selected from the group consisting of the software Application, Email, SMS, and a social network, to the software Application within the first mobile communication device through the Cloud.
